(19) United States
(12) Patent Application Publication
(10) Pub. No.: US 2026/0331949 A1
(43) Pub. Date: Oct. 22, 2026

(54) CONTACTLESS ENERGY TRANSMISSION DEVICE, KIT-OF-PARTS FOR PRODUCING A CONTACTLESS ENERGY TRANSMISSION DEVICE, ROTOR OF AN ELECTRIC MACHINE, ELECTRIC MACHINE, AND METHOD FOR INSTALLING A ROTOR

(71) Applicant: Schaeffler Technologies AG & Co. KG, Herzogenaurach (DE)

(72) Inventors: Martin Kunkemoeller, Sasbach (DE); Thomas Hurle, Bühlertal (DE); Christian Hartmann, Emskirchen (DE); Richard Bernauer, Weilheim (DE); Jan Michel Wassermann, München (DE); Christian Oehler, Tutzing (DE); Kevin Klumpp, Ellenberg (DE)

(73) Assignee: Schaeffler Technologies AG & Co. KG, Herzogenaurach (DE)

(21) Appl. No.: 19/113,981

(22) PCT Filed: Sep. 19, 2023
(86) PCT No.: PCT/DE2023/100700

§ 371 Date: Mar. 21, 2025

(30) Foreign Application Priority Data
Sep. 23, 2022 (DE) 10 2022 124 446.6

(51) Int. Cl. H02J 50/00; H02J 50/10; H02K 7/00; H02K 11/00; H02K 15/40

(52) U.S. Cl. CPC H02J 50/005; H02J 50/10; H02K 7/003; H02K 11/0094; H02K 15/40

(57) ABSTRACT

A contactless energy transmission device for a rotor of an electric machine, such as an externally excited synchronous machine within a powertrain of a motor vehicle is provided. The device includes a hollow shaft which can be coupled to the rotor of the electric machine to transmit a torque. The device also includes an inductive transformer which has a primary winding that can be energized and a secondary winding that is arranged at a distance thereto and can be coupled to a winding of the rotor in an electrically conductive manner. The secondary winding of the inductive transformer is arranged within the hollow shaft and is fixed to the same for co-rotation therewith, while the primary winding of the inductive transformer is positioned in the hollow shaft in a non-rotatable manner relative thereto.

### CROSS-REFERENCE TO RELATED APPLICATIONS

This application is the United States National Phase of PCT Application PCT/DE2023/100700, filed Oct. 19, 2023, which claims priority to German Application 10 2022 124 446.6, filed Oct. 23, 2022. The disclosures of the above applications are incorporated herein by reference.

### TECHNICAL FIELD

The present disclosure relates to a contactless energy transmission device for a rotor of an electric machine, such as a separately excited synchronous machine inside a drive train of a motor vehicle, having a hollow shaft which can be coupled to the rotor of the electric machine in a torque-transmitting manner, and an inductive transmitter which has an energizable primary winding and a secondary winding which is spaced apart therefrom, which can be electrically conductively coupled to a winding of the rotor. The disclosure further relates to a kit-of-parts for producing a contactless energy transmission device, a rotor of an electric machine and an electric machine.

### BACKGROUND

Electric machines are increasingly being used to drive motor vehicles to create alternatives to internal combustion engines that require fossil fuels. Significant efforts have already been made to improve the suitability of electric drives for everyday use and also to be able to offer users the driving comfort which they are accustomed to.

A detailed description of an electric drive can be found in an article in the German automotive magazine ATZ, volume 113, 05/2011, pages 360-365 by Erik Schneider, Frank Fickl, Bernd Cebulski and Jens Liebold with the title: Hochintegrativ und Flexibel Elektrische Antriebseinheit für E-Fahrzeuge [Highly Integrative and Flexible Electric Drive Unit for E-Vehicles]. This article describes a drive unit for an axle of a vehicle, which includes an electric motor. Such drive units are also referred to as e-axles or electrically operable drive trains.

In addition to purely electrically operated drive trains, hybrid drive trains are also known. Such drivetrains of a hybrid vehicle usually comprise a combination of an internal combustion engine and an electric motor, and enable, for example in urban areas, a purely electric mode of operation while at the same time permitting both sufficient range and availability, such as when driving cross-country. In addition, drive can also be provided by the internal combustion engine and the electric motor at the same time in certain operating situations.

When developing the electric machines intended for e-axles or hybrid modules, there is a continuing need to increase their power density and efficiency while reducing manufacturing costs, since the cost and weight of the vehicle will be largely determined by the battery size. In this context, it is also known to design the electric machines as separately excited synchronous machines (SESM). In this case, the electrical output for exciting the rotor windings must be transmitted to the rotor of a separately excited synchronous machine. For traction machines, a contact-based transmitter is usually used for this purpose. When these windings are energized, a magnetic field is created which, in combination with the magnetic field of the stator, generates a torque.

The strength of the rotor field can be adjusted by the strength of the current supply. In this way, the machine behavior can always be adapted to the respective driving situation in the most efficient way possible.

The disadvantages of such a contact-based transmitter are mechanical and electrical losses in the contact between stationary and rotating components. Further disadvantages are the wear of the components rubbing against each other, the resulting contamination caused by abrasion and the comparatively large installation space requirement.

As an alternative to such contact-based transmitters, contactless, inductive transmitters are also known, for example. An inductive transmitter is usually a rotationally symmetrical transmitter with an air gap consisting of a primary and a secondary winding. As a rule, an inductive transmitter also has a core made of ferrite, for example. Such a core can be made of one or more parts.

For example, all parts of the core can be attached to the stationary machine side of an electric machine, wherein the secondary side winding rotates inside the core. Alternatively, core parts can be attached to the rotating part of the machine. In this case, the primary and secondary core parts are separated by an air gap. This must be large enough to ensure that the core parts do not touch each other, taking into account all tolerances and operating conditions. For this purpose, the rotating transmitter parts are often banded for this purpose or joined to another component to provide support that can withstand the speed of rotation. An example of such a design variant can be found in DE 10 2017 214 776 A1 or in DE201210201826 A1.

### SUMMARY

One aspect of the disclosure provides a contactless energy transmission device for a rotor of an electric machine, such as a separately excited synchronous machine inside a drive train of a motor vehicle. The contactless energy transmission device includes a hollow shaft which may be coupled to the rotor of the electric machine in a torque-transmitting manner, and an inductive transmitter which has an energizable primary winding and a secondary winding which is spaced apart therefrom, which can be electrically conductively coupled to a winding of the rotor. The secondary winding of the inductive transmitter is arranged inside the hollow shaft and is connected thereto for conjoint rotation therewith, while the primary winding of the inductive transmitter is positioned therein in a torsionally rigid manner relative to the hollow shaft.

In some implementations, the inductive transmitter is thus integrated into the interior of the hollow shaft. For this purpose, the secondary-side rotating part is inserted into the interior of the hollow shaft. The primary-side, standing part may be arranged coaxially inside the secondary-side part. The inductive transmitter may thus be dimensioned to be comparatively long axially and comparatively compact radially. Due to the coaxial arrangement inside the hollow shaft and the axially comparatively long but radially comparatively compact design in connection with a radial air gap, a number of advantages can be realized, which are explained in more detail below.

First of all, the separately excited synchronous machine can be designed to be very compact axially, since no additional installation space needs to be provided for a transmitter, as the installation space available in the hollow shaft is used.

The rotating transmitter part with the secondary winding is supported at a fixed speed by the hollow shaft. The radially compact dimensions of the secondary winding reduce its circumferential speed and thus the centrifugal force acting thereon. This results in reduced strength requirements for the materials used and the assembly.

The radial separation between the primary winding and the secondary winding of the inductive transmitter in conjunction with a low tolerance chain for the rotor bearing enables the air gap between the primary and secondary transmitter parts to be minimized, which favors a reduction in the size of the transmitter components.

The axially comparatively long and radially comparatively compact dimensions also reduce stray flux components in the inductive transmitter, which also favors a reduction in the size of the transmitter components.

Furthermore, the inductive transmitter can be positioned relatively far away from the rotor windings, which become hot during operation, so that heating of the transmitter by the rotor windings is avoided. If the hollow shaft is additionally cooled, e.g., by a cooling fluid inside the hollow shaft, the losses of the inductive transmitter can be further positively influenced.

If the hollow shaft is made of an electrically conductive material, e.g., steel, it shields the inductive transmitter from surrounding components and systems and thus contributes to electromagnetic compatibility (EMC) with respect to surrounding components and systems.

The hollow shaft can be formed integrally or in several parts. If the hollow shaft is made up of several parts, these hollow shaft parts can only be joined together after the inductive transmitter has been integrated.

The inductive transmitter can be integrated at any axial position inside the hollow shaft. For example, in the area of a laminated rotor core or in the area of the rotor winding heads.

In some implementations, the secondary winding of the inductive transmitter is arranged inside the hollow shaft. The secondary coil may be positioned axially completely in the hollow shaft. However, it would also be conceivable that the secondary coil only engages axially in sections of the hollow shaft.

A rotor is the spinning (rotating) part of an electric machine. The rotor includes a rotor shaft. The rotor shaft can be hollow, which on the one hand results in weight savings and on the other hand allows the supply of lubricant or coolant to the rotor body. In some examples, the hollow shaft of the contactless energy transmission device is a rotor shaft of a rotor of an electric machine that is hollow at least in sections.

The electric machine may be designed as a rotary machine. The rotary machine may be configured as a radial flux machine. A radial flux machine is characterized by the fact that the magnetic field lines in the air gap formed between the rotor and stator extend in a radial direction. The gap between the rotor and the stator is referred to as the air gap. In a radial flux machine, this is a gap with a circular cross-section and a radial width that corresponds to the distance between the rotor body and the stator body.

The electric machine is used inside a drive train of a hybrid or fully electrically driven motor vehicle. The electric machine may be dimensioned such that vehicle speeds of more than 50 km/h, for example more than 80 km/h, and such as more than 100 km/h may be achieved. The electric motor may have an output of more than 50 kW, for example more than 80 kW, and such as more than 150 kW. Furthermore, the electric machine provides speeds greater than 8000 rpm, for example greater than 12,000 rpm, such as greater than 1500 rpm.

For the purposes of this application, motor vehicles are land vehicles that are moved by machine power without being bound to railroad tracks. A motor vehicle can be selected, for example, from the group of passenger cars, trucks, small motorcycles, light motor vehicles, motorcycles, motor buses/coaches or tractors.

The inductive transmitter can be arranged inside a hollow shaft. The hollow shaft can be formed integrally or in several parts. It is fundamentally conceivable that the hollow shaft is penetrated completely or only in sections by an opening running in the longitudinal extension of the hollow shaft. For example, it would also be conceivable for the hollow shaft to have a blind hole, into which the inductive transmitter can then be inserted. The hollow shaft may be made of a metallic material, such as steel.

The inductive transmitter is configured such that electrical output, for example greater than 1 kW and such as greater than 2 kW, can be transmitted at least briefly without electrically or thermally overloading the transmitter. In some examples, the inductive transmitter is configured to transmit electrical output between 0.5 kW-10 kW, such as between 1 kW-5 kW, or between 2 kW-4 kW.

The windings of the transmitter are made of an electrically conductive but non-ferromagnetic material, such as copper or aluminum, and are electrically insulated from each other. In some examples, the windings are aligned tangentially around the hollow shaft, resulting in a cylindrical ring-shaped winding body with a diameter and a longitudinal extension in the axial direction. The windings may be wound around and/or in a core made of a ferromagnetic material.

The windings can be formed from one or more electrical conductors with a circular cross-section. It is also conceivable that the electrical conductors forming the winding have a cross-sectional shape that deviates from the circular shape, such as a rectangular shape. In some examples, the windings is formed from insulated copper foils that are wound around each other in a similar way to a toilet paper roll.

According to an advantageous further development of the disclosure, the primary winding can have a higher number of windings than the secondary winding. This means that, when the electrical energy is transferred between the primary winding and the secondary winding, a voltage conversion from the comparatively high battery voltage to the lower rotor voltage can be realized.

In this context, an electrical voltage of 40-1500V, for example 100-1000V, such as 300-850V is applied to the primary winding. Furthermore, a voltage of 70-500 V may be applied to the secondary winding.

The primary core and/or the secondary core are/is made of a ferromagnetic material, such as a ferrite material. The primary core and/or secondary core can be designed in several parts. The respective core parts are substantially rotationally symmetrical, but can contain elements and recesses for fixing or feeding through additional components.

In some implementations, the primary core and/or the secondary core each have a ring-shaped spatial form. For example, the primary core and/or the secondary core have a U-shaped cross-sectional contour with a circumferential groove. The grooves of the U-shaped cross-sectional contours of the primary core and secondary core may be directed towards each other. In some examples, the primary winding goes into the groove of the primary core and/or the secondary winding goes into the groove of the secondary core.

In some implementations, the cylindrical ring-shaped secondary winding has a radial outer diameter of less than 500 mm, for example less than 400 mm, such as less than 350 mm. The radial outer diameter of the cylindrical ring-shaped secondary winding may be selected to be between 100-500 mm, such as 150-400 mm, for example 200-350 mm. This allows the centrifugal forces acting during operation to be limited to an advantageous size.

The axial length of the cylindrical ring-shaped secondary winding may be greater than 50%, for example greater than 70% of the radial outer diameter, such as of the diameter of the secondary winding. Such an “elongated” design of the winding has proven to be advantageous for energy transmission of the inductive transmitter. In simple terms, flat and elongated designs of the cylindrical ring-shaped secondary windings have proven to be favorable with regard to the energy transfer properties of the inductive transmitter.

In some implementations, the axial length of the cylindrical ring-shaped primary winding is between 80-120% of the axial length of the cylindrical ring-shaped secondary winding, which can also contribute to a good energy transfer between the windings.

Furthermore, it is advantageous that the two axial lengths of the cylindrical ring-shaped windings completely overlap axially, whereby the energy transfer between the primary winding and the secondary winding can be further optimized.

Furthermore, it can be advantageous for the primary core and secondary core to each form surfaces bordering the air gap, via which the magnetic flux is guided from one part to the other. It is advantageous if the surfaces of the primary core bordering the air gap completely cover the surfaces of the secondary core bordering the air gap and/or if the surfaces of the secondary core bordering the air gap completely cover the surfaces of the primary core bordering the air gap, where the energy transfer between the primary winding and the secondary winding can be further optimized.

Rectifier electronics may be connected between the secondary winding and a winding of the rotor, such that the secondary winding energizes the winding of the rotor with the rectifier electronics interconnected.

The primary winding can be rotatably mounted and centered relative to the secondary winding, by way of one or more rolling bearings. For this purpose, rolling elements are arranged so as to roll between an inner ring and an outer ring of the rolling bearing.

The inner ring can be made of a metallic and/or ceramic material. In principle, it is conceivable to design the inner ring in one part or in multiple parts, for example in two parts. The inner ring can have an inner ring groove. In some examples, a cover washer, sealing washer and/or seal can be arranged in an inner ring groove, such as in a force-fitting and/or form-fitting manner. For example, the inner ring groove is formed as a circumferential groove in the inner ring.

The outer ring can be made of a metallic and/or ceramic material. In principle, it is conceivable to form the outer ring in one part or in multiple parts, for example in two parts. The outer ring can have an outer ring groove. A cover washer, sealing washer and/or seal may be arranged in an outer ring groove, for example in a force-fitting and/or form-fitting manner. The outer ring groove may be formed as a circumferential groove in the outer ring.

Depending on the type of rolling bearing, the rolling elements have the shape of a sphere or a cylinder. Roller-shaped rolling elements are also referred to as roller bearing elements and spherical rolling elements as bearing balls. Roller-like rolling elements can be selected, for example, from the group of symmetrical spherical rollers, asymmetrical spherical rollers, cylindrical rollers, needle rollers and/or tapered rollers.

The rolling elements can roll inside the rolling bearing, for example on the inner ring raceway of the inner ring. For this purpose, the surface of the inner ring raceway can advantageously be designed to be correspondingly abrasion-resistant, for example by way of a corresponding surface treatment method and/or by applying a corresponding additional layer of material. The inner ring raceway can be designed to be planar or profiled. A profiled design of the inner ring raceway can be used, for example, to guide the rolling elements on the inner ring raceway. On the other hand, a planar formation of the inner ring raceway can, for example, allow a certain axial displaceability of the rolling elements on the inner ring raceway.

The rolling elements can roll inside the rolling bearing, for example on the outer ring raceway of the outer ring. For this purpose, the surface of the outer ring raceway can advantageously be designed to be abrasion-resistant, for example by way of a corresponding surface treatment method and/or by applying a corresponding additional layer of material.

The outer ring raceway can be designed to be planar or profiled. A profiled design of the outer ring raceway can be used, for example, to guide the rolling elements on the outer ring raceway. On the other hand, a planar formation of the outer ring raceway can, for example, allow a certain axial displaceability of the rolling elements on the outer ring raceway.

Rolling elements can be guided and spaced apart in a cage or by rolling element spacers. In principle, it is also conceivable to design a rolling bearing without a cage, which is also referred to as a full-complement rolling bearing. In full-complement rolling bearings, adjacent rolling elements can contact one another.

A rolling bearing can have a cage, where the cage guides the rolling elements. The cage is designed such that the rolling element balls and/or the rolling element rollers are spaced apart from one another so that, for example, the friction and heat development of the rolling elements is kept as low as possible. Furthermore, the cage keeps the rolling element balls and/or rolling element rollers at a fixed distance from one another during rolling, as a result of which an even load distribution can be achieved. The cage can be formed integrally or in several parts.

A rolling bearing can have a seal in order to prevent the escape of lubricant from the rolling bearing or the ingress of dirt or moisture into the rolling bearing. For this purpose, the seals used can be provided with one or more sealing lips, which can bear against a component of the rolling bearing. These are designed such that, on the one hand, they seal the bearing as long as possible over its entire service life, and on the other hand, the level of friction caused by the contiguous seal is not too high.

Another aspect of the disclosure provides a method for assembling a rotor of an electric machine, such as a separately excited synchronous machine inside a drive train a motor vehicle. The method includes:
providing an inductive transmitter which has an energizable primary winding and a secondary winding which is spaced apart therefrom and can be electrically conductively coupled to a winding of the rotor, and
providing a hollow shaft which can be coupled to the rotor of the electric machine in a torque-transmitting manner, and
inserting the inductive transmitter into the hollow shaft.

Furthermore, it can be provided that the rolling bearing has an inner ring and an outer ring, between which a plurality of rolling elements is accommodated, where the inner ring is connected to the hollow shaft for conjoint rotation and the outer ring is connected to the lance for conjoint rotation. This may support a modular configuration of the rolling bearing and the hollow shaft. For this purpose, it is then further advantageous that the lance has a first cylinder ring section, on the outer lateral surface of which the primary winding is arranged, and the lance also has a second cylinder ring section arranged coaxially to the first cylinder ring section, on the inner lateral surface of which the outer ring of the rolling bearing is arranged, where the first cylinder ring section has a smaller diameter than the second cylinder ring section. Furthermore, in some examples the rolling bearing, the hollow shaft, the lance and the inductive transmitter form a modular structural unit.

In some implementations, a method for assembling a rotor of an electric machine, such as a separately excited synchronous machine inside a drive train of a motor vehicle, includes:
providing a rotor shaft,
providing a contactless energy transmission device,
connecting the hollow shaft of the contactless energy transmission device to the rotor shaft,
Coupling of the secondary winding with a winding of the rotor, and
The contactless energy transmission device can have rectifier electronics connected to the secondary winding.

In some examples, the contactless energy transmission device has rectifier electronics, which are also arranged inside the hollow shaft and are connected thereto for conjoint rotation therewith.

In some examples, the rectifier electronics have a circuit board with electronic components arranged thereon, where the circuit board has a substantially disc-shaped or circular disc-shaped or cylindrical ring-shaped contour.

In some implementations, the circuit board is not completely closed on its circumference or is made up of several segments. The circuit board may have a contour in the shape of a disc section, a circular disc section or a cylindrical ring section.

In some examples, the circuit board is connected to the hollow shaft in a materially-bonded, force-fitting and/or form-fitting manner for conjoint rotation. Alternatively, the rectifier electronics may be accommodated in a housing that has a contour substantially in the shape of a disc, disc section or circular disc, circular disc section, cylindrical ring or cylindrical ring section and the housing is connected to the hollow shaft in a materially-bonded, force-fitting and/or form-fitting manner for conjoint rotation. The housing can provide additional mechanical, chemical or electromagnetic protection for the rectifier electronics. The housing can, for example, be made of a plastic or a metallic material. The housing can be designed as a single part or multiple parts.

The rectifier electronics can also be encapsulated in an electrically non-conductive material.

Furthermore, in some examples, a cooling fluid can flow through the hollow shaft such that heat generated by the rectifier electronics can be dissipated by the cooling fluid when the contactless energy transmission device is in operation, which favors low-loss operation of the inductive transmitter.

Another aspect of the disclosure provides a kit-of-parts for producing a contactless energy transmission device for a rotor of an electric machine, such as a separately excited synchronous machine inside a drive train of a motor vehicle. The kit-of-parts then includes:
an inductive transmitter which has an energizable primary winding and a secondary winding which is spaced apart therefrom and can be electrically conductively coupled to a winding of the rotor,
a hollow shaft which can be coupled to the rotor of the electric machine in a torque-transmitting manner, and
rectifier electronics which can be connected to the secondary winding, which can be positioned inside the hollow shaft and can be connected thereto for conjoint rotation therewith.

This allows the components necessary for producing the energy transmission device to be made available in a particularly convenient manner. The kit-of-parts can, for example, be a packaging unit. Furthermore, it is possible to design the kit-of-parts as a compilation of separate storage containers for storing the individual components or the respective component groups of the kit-of-parts.

Yet another aspect of the disclosure provides a method for assembling a rotor of an electric machine, such as a separately excited synchronous machine inside a drive train of a motor vehicle. Such an assembly process then includes:
providing a hollow shaft which can be coupled to the rotor of the electric machine in a torque-transmitting manner,
providing an inductive transmitter which has an energizable primary winding and a secondary winding which is spaced apart therefrom and can be electrically conductively coupled to a winding of the rotor,
providing rectifier electronics which can be coupled to the secondary winding,
inserting the rectifier electronics into the hollow shaft so that the rectifier electronics are connected to the hollow shaft for conjoint rotation, and
connecting the rectifier electronics to the secondary winding of the inductive transmitter.

In some implementations, the primary winding and the secondary winding of the inductive transmitter are arranged coaxially to one another inside the hollow shaft. The advantage of this example is that it enables particularly efficient electrical energy transmission.

In some examples, the primary winding is arranged on a lance extending axially into the interior of the hollow shaft. The lance can be designed as a hollow cylindrical shaft.

The lance may have at least one cooling channel, through which a cooling fluid can flow. The advantageous effect of this example is based on the fact that it enables particularly good cooling of the primary winding.

In some examples, the contactless energy transmission device has rectifier electronics, which are also arranged inside the hollow shaft and are connected thereto for conjoint rotation therewith. In principle, the electronics for rectification can be placed anywhere in or on the rotor. However, the electronics for rectification may also be positioned inside the hollow shaft, since the conditions here are also more favorable for these in terms of speed stability and thermal conditions.

In some examples, the lance is mounted opposite the hollow shaft by a rolling bearing located in the hollow shaft. The advantage of this example is that it allows a particularly tolerant and thus small annular gap to be formed between the primary coil and the secondary coil.

Another aspect of the disclosure provides a kit-of-parts for producing a contactless energy transmission device for a rotor of an electric machine, such as a separately excited synchronous machine inside a drive train of a motor vehicle, including an inductive transmitter which has an energizable primary winding and a secondary winding which is spaced apart therefrom, which can be electrically conductively coupled to a winding of the rotor, a hollow shaft which can be coupled to the rotor of the electric machine in a torque-transmitting manner, and the secondary winding of the inductive transmitter is arranged inside the hollow shaft and connected thereto for conjoint rotation therewith, and a lance that can be inserted axially into the interior of the hollow shaft, on which the primary winding of the inductive transmitter is arranged.

The resulting advantage is that the components of the contactless energy transmission device to be assembled can be provided in a particularly convenient manner. The kit-of-parts can, for example, be a packaging unit. Furthermore, it is possible to design the kit-of-parts as a compilation of separate storage containers for storing the individual components or the respective component groups of the kit-of-parts.

Another aspect of the disclosure provides a rotor of an electric machine, such as a separately excited synchronous machine inside a drive train of a motor vehicle, having a contactless energy transmission device.

Finally, another aspect of the disclosure provides an electric machine, such as a separately excited synchronous machine inside a drive train of a motor vehicle, having a rotor.

The disclosure is explained in more detail below with reference to figures without limiting the general concept of the invention.

### DESCRIPTION OF DRAWINGS

FIG. 1 shows an electric machine with a contactless energy transmission device in a schematic axial sectional view,

FIG. 2 shows a detailed view of the contactless energy transmission device in an axial sectional view,

FIG. 3 shows a kit-of-parts for producing a contactless energy transmission device for a rotor of an electric machine,

FIG. 4 shows a motor vehicle with an electric machine in a block diagram.

FIG. 5 shows an inductive transmitter in a perspective partial sectional view,

FIG. 6 shows a first exemplary arrangement of rectifier electronics in a hollow shaft in an axial sectional view,

FIG. 7 shows a second exemplary arrangement of rectifier electronics in a hollow shaft in an axial sectional view,

FIG. 8 shows a third exemplary arrangement of rectifier electronics in a hollow shaft in an axial sectional view,

FIG. 9 shows a fourth exemplary arrangement of rectifier electronics in a hollow shaft in an axial sectional view,

FIG. 10 shows a fifth exemplary arrangement of rectifier electronics in a hollow shaft in an axial sectional view,

FIG. 11 shows a sixth exemplary arrangement of rectifier electronics in a hollow shaft in an axial sectional view,

FIG. 12 shows a detailed view of a contactless energy transmission device inside a rolling bearing in an axial sectional view,

FIG. 13 shows a kit-of-parts for producing a contactless energy transmission device for a rotor of an electric machine.

Like reference symbols in the various drawings indicate like elements.

### DETAILED DESCRIPTION

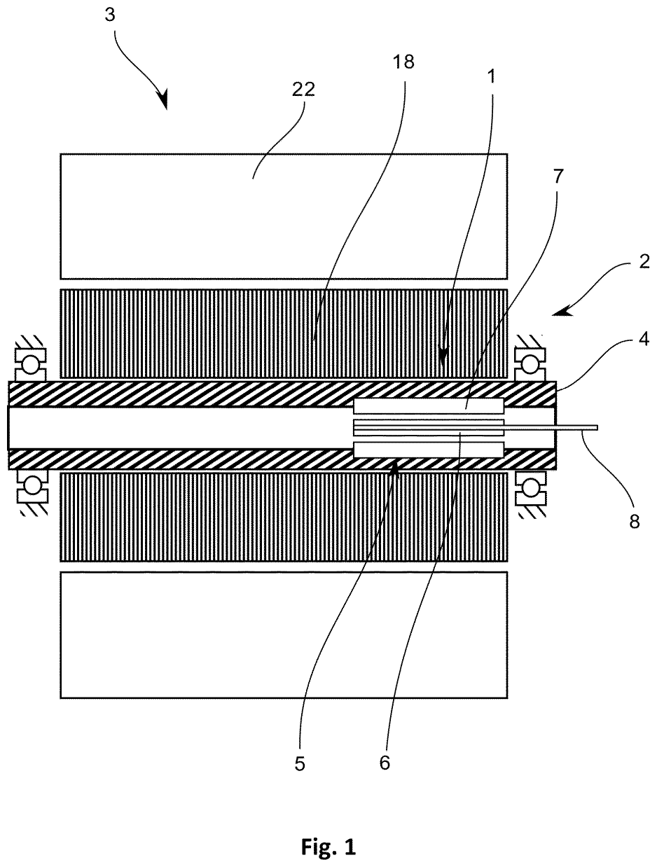

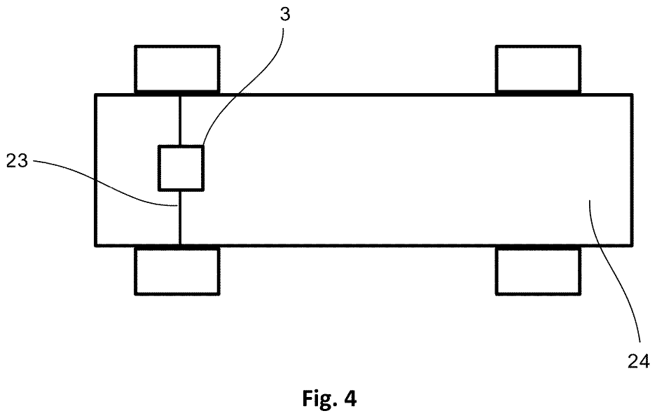

FIG. 1 shows a contactless energy transmission device 1 for a rotor 2 of an electric machine 3. As shown in FIG. 1, the electric machine 3 is configured as a separately excited synchronous machine for a drive train 23 of a motor vehicle 24, as is also outlined by way of example in FIG. 4.

The rotor 2, which is rotatably mounted in the cylindrical ring-shaped stator 22, has a hollow shaft 4 which is connected to the rotor 2 of the electric machine 3 in a torque-transmitting manner. The rotor 2 also includes a laminated rotor stack 18 which is connected to the hollow shaft 4 for conjoint rotation. The hollow shaft 4 thus forms the rotor shaft of the rotor 2.

An inductive transmitter 5 is provided to energize the rotor 2, which inductive transmitter 5 has an energizable primary winding 6 and a secondary winding 7 spaced apart therefrom, which is electrically conductively coupled to a winding of the rotor 2.

As can be clearly seen from FIG. 1, the secondary winding 7 of the inductive transmitter 5 is arranged inside the hollow shaft 4 and is connected thereto for conjoint rotation therewith, while the primary winding 6 of the inductive transmitter 5 is positioned therein in a torsionally rigid manner relative to the hollow shaft 4, such that the secondary winding 7 rotates around the primary winding 6. The primary winding 6 and the secondary winding 7 of the inductive transmitter 5 are arranged coaxially to one another inside the hollow shaft 4. The primary winding 6 is arranged on a lance 8 extending axially into the interior of the hollow shaft 4.

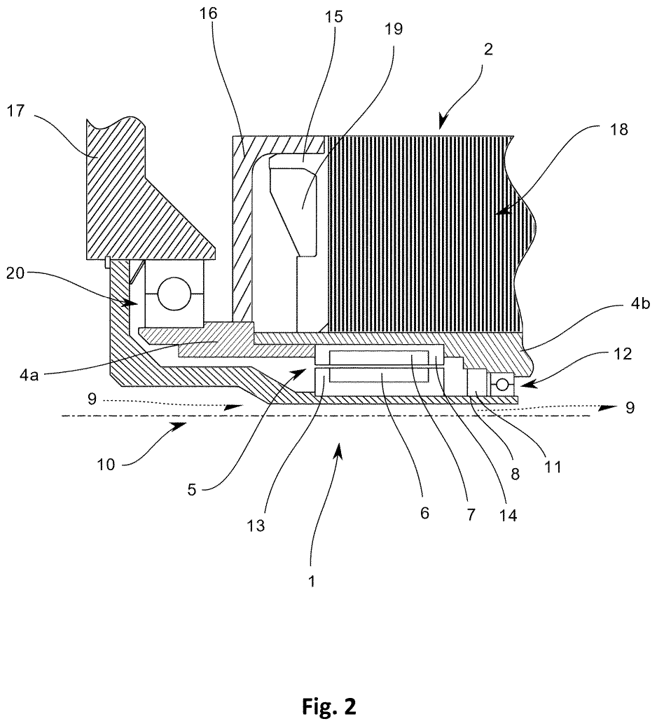

From FIG. 2, it can be clearly seen that the lance 8 can be designed in the shape of a cylindrical ring and then has an axially extending cooling channel 10, through which a cooling fluid 9 can flow. This ensures that the heat generated at the primary winding 6 can be efficiently dissipated. The hollow shaft 4 shown in FIG. 2 is designed in two parts and consists of a first hollow cylindrical shaft section 4a and a second hollow cylindrical shaft section 4b, which are connected to each other for conjoint rotation.

As shown in FIG. 2, the contactless energy transmission device 1 also has rectifier electronics 11, which can also be arranged inside the hollow shaft 4 and connected thereto for conjoint rotation therewith. In principle, it would also be conceivable to provide a seal between the hollow shaft 4 and the lance 8 in order to protect the inductive transmitter 5 from the ingress of dirt and/or cooling fluid, which, however, is not shown in the figures.

The laminated rotor core 18 of the rotor 2 is connected to the radially outer lateral surface of the hollow shaft 4 for conjoint rotation. From this, the rotor winding head 19 extends in the axial direction from the distal end face of the laminated rotor core 18.

FIG. 2 further shows that the hollow cylindrical lance 8 can be mounted relative to the hollow shaft 4 by a rolling bearing 12 arranged in the hollow shaft 4.

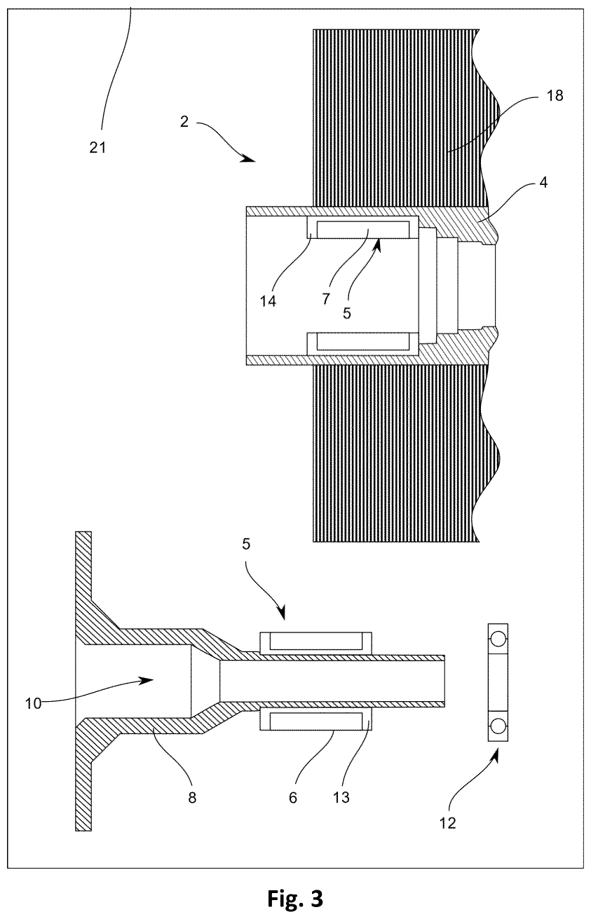

In FIG. 3, a kit-of-parts 21 for producing a contactless energy transmission device 1 for a rotor 2 of an electric machine 3, such as a separately excited synchronous machine inside a drive train of a motor vehicle, is shown. For example, the kit-of-parts 21 can be used for converting or equipping an electric machine 3 from a contact-based power supply of a rotor 2 to a contactless power supply and provides the corresponding equipment components for this purpose.

The kit-of-parts 21 includes an inductive transmitter 5 which has an energizable primary winding 6 and a secondary winding 7 which is spaced apart therefrom and can be electrically conductively coupled to a winding of the rotor 2, and a hollow shaft 4 which can be coupled to the rotor 2 of the electric machine 3 in a torque-transmitting manner. In doing so, the secondary winding 7 of the inductive transmitter 5 is arranged inside the hollow shaft 4 and connected thereto for conjoint rotation therewith. The kit-of-parts 21 further includes a lance 8 that can be inserted axially into the interior of the hollow shaft 4, on which the primary winding 6 of the inductive transmitter 5 is arranged. This means that, for example, an existing hollow shaft can be exchanged and replaced by the hollow shaft of the kit-of-parts 21. Subsequently, the cylindrical ring-shaped lance 8 can then be inserted into the hollow shaft 4, where the primary winding 6 and the secondary winding 7 are then aligned coaxially with each other, as is also shown in the assembled state of the lance 8 in FIG. 2. The rolling bearing 12 in the kit-of-parts 21 is provided as an option for mounting the cylindrical ring-shaped lance 8.

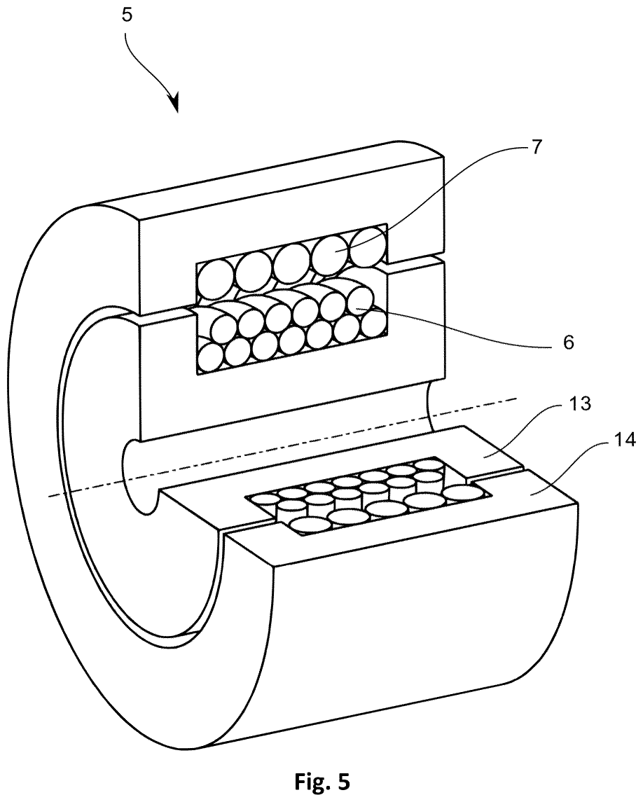

FIG. 5 shows a detailed view of the inductive transmitter 5. The primary core 13 and the secondary core 14, each of which has a ring-shaped spatial form, can be seen. Both the primary core 13 and the secondary core 14 have a U-shaped cross-sectional contour with a circumferential groove, where the grooves of the U-shaped cross-sectional contours of the primary core 13 and the secondary core 14 are directed towards each other.

The primary winding 6 goes into the groove of the primary core 13 and the secondary winding 7 into the groove of the secondary core 14. The primary core 13 and the secondary core 14 are made of a ferromagnetic material, such as a ferrite material.

As shown in FIG. 5, the primary winding 6 has a higher number of windings than the secondary winding 7, so that, when the electrical energy is transferred between the primary winding 6 and the secondary winding 7, a voltage conversion from the comparatively high battery voltage to the lower rotor voltage can be realized at the same time.

The two axial lengths of the cylindrical ring-shaped windings 6,7 overlap almost completely axially, which allows for an optimal and loss-free energy transfer between the primary winding 6 and the secondary winding 7.

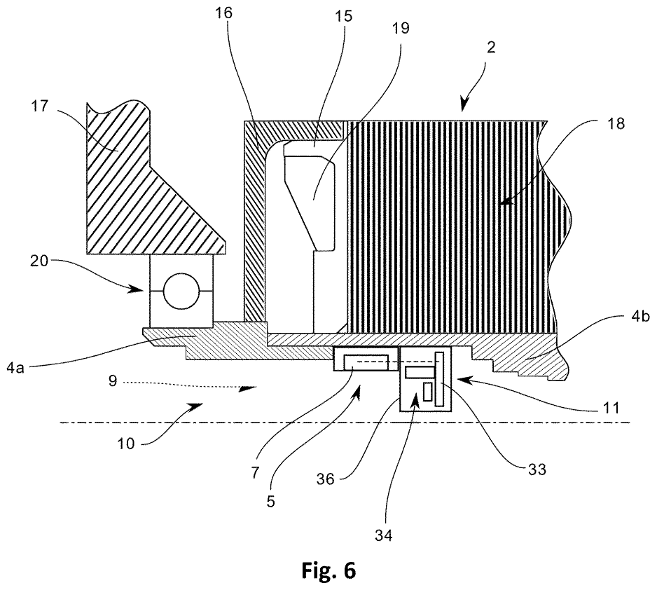

FIGS. 6-11 show various possibilities for arranging the rectifier electronics 11 inside the hollow shaft 4.

In all examples of FIGS. 6-11, the contactless energy transmission device 1 is connected to the secondary winding 7 with rectifier electronics 11. The rectifier electronics 11 are each arranged inside the hollow shaft 4 and are connected thereto for conjoint rotation therewith.

As shown in FIGS. 6-11, the secondary winding 7 of the inductive transmitter 5 is arranged inside the hollow shaft 4 and is connected thereto for conjoint rotation therewith, while the primary winding 6 of the inductive transmitter 5 is positioned therein in a torsionally rigid manner relative to the hollow shaft 4, which, however, is not shown in FIGS. 6-11 for reasons of clarity.

The rectifier electronics 11 have a circuit board 33 with electronic components 34 arranged thereon.

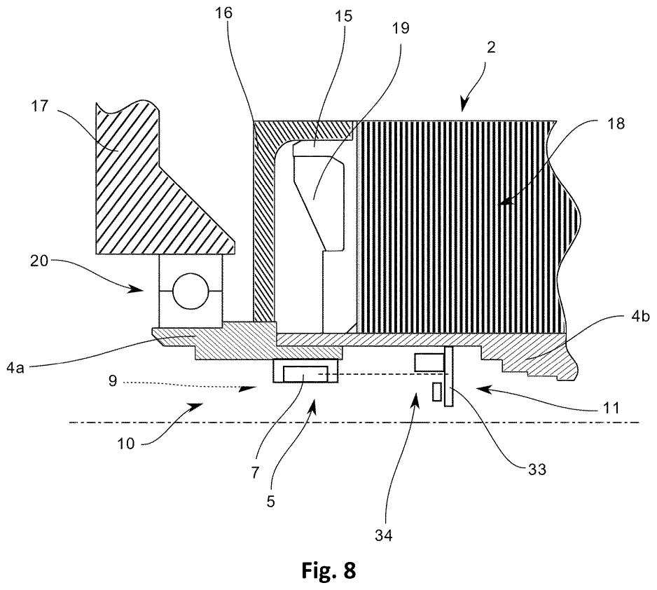

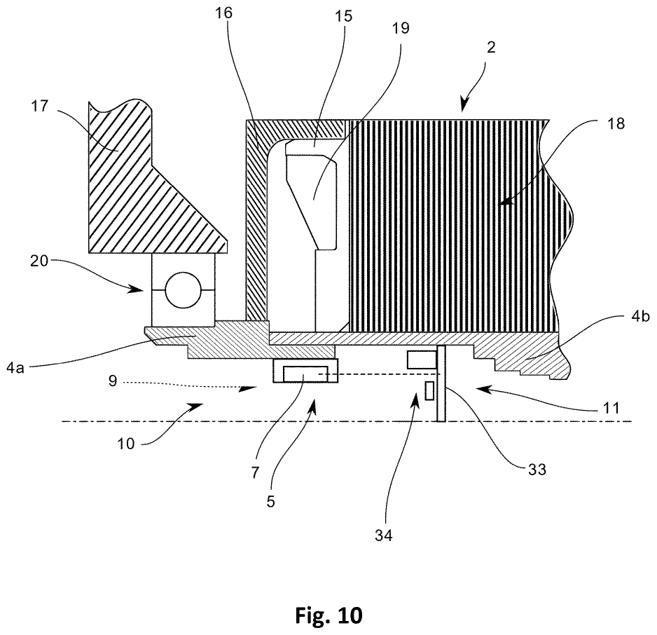

As shown in FIG. 10, the circuit board 33 has a substantially disc-shaped or disc section-shaped contour which extends substantially in the radial direction inside the hollow shaft 4. FIG. 8 shows a similar configuration, in which, however, the circuit board 33 has a circular disc-shaped or circular disc section-shaped contour, so that the circuit board 33 can be passed through and/or flowed through in the axial direction.

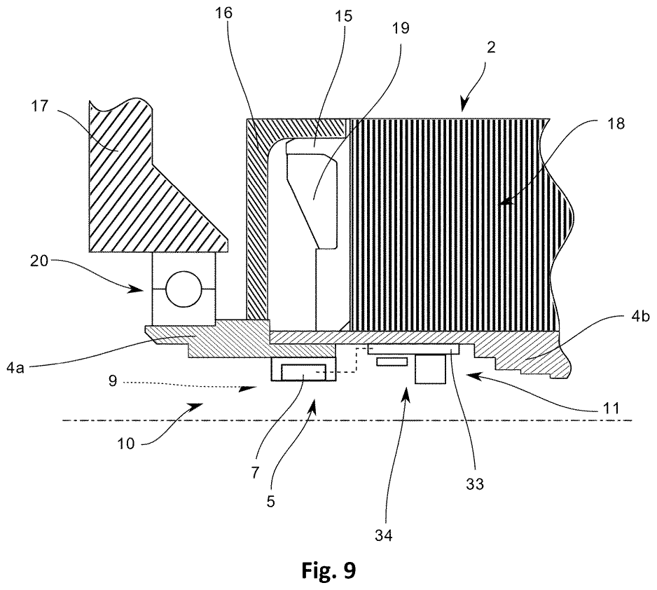

FIG. 9 shows a further possible arrangement of the circuit board 33, in which the circuit board 33 has a cylindrical ring-shaped or cylindrical ring section-shaped contour and extends substantially in the axial direction inside the hollow shaft 4.

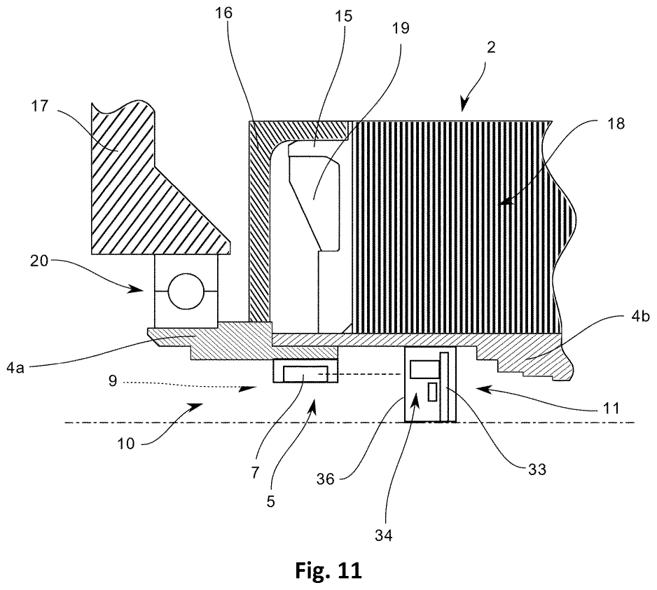

FIGS. 6, 7, 11 show further exemplary rectifier electronics 11, in which the rectifier electronics 11 are accommodated in a housing 36, which in turn is connected to the hollow shaft 4 in a materially-bonded, force-fitting and/or form-fitting manner for conjoint rotation. As shown in FIG. 11, the housing 36 has a substantially disc-shaped or disc section-shaped contour.

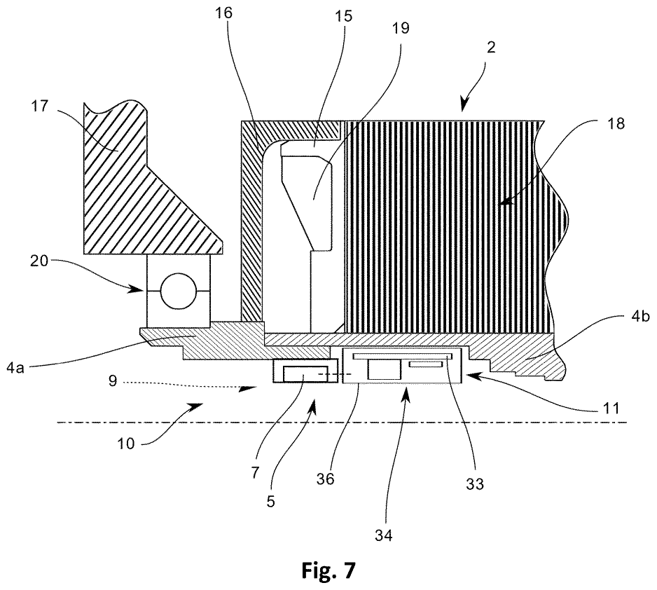

The housing 36 can also have a circular disc-shaped or circular disc section contour, as can also be seen in FIG. 6. As a result, the housing 36 can be passed through, for example, by the lance 8 or by a cooling fluid 9. As shown in FIGS. 6 and 11, the housing extends like a circular disc substantially in the radial direction. In principle, it is also possible for the housing 36 to extend in the axial direction, as shown in FIG. 7. The housing has a cylindrical ring-shaped or cylindrical ring section-shaped contour.

As can also be seen from FIGS. 6-11, the hollow shaft 4 is designed so that a cooling fluid 9 can flow through it in such a way that heat generated by the rectifier electronics 11 can be dissipated by the cooling fluid 9 when the contactless energy transmission device 1 is in operation. For this purpose, the hollow shaft 4 is also used as a cooling channel 10, through which the cooling fluid 9 can be conveyed axially.

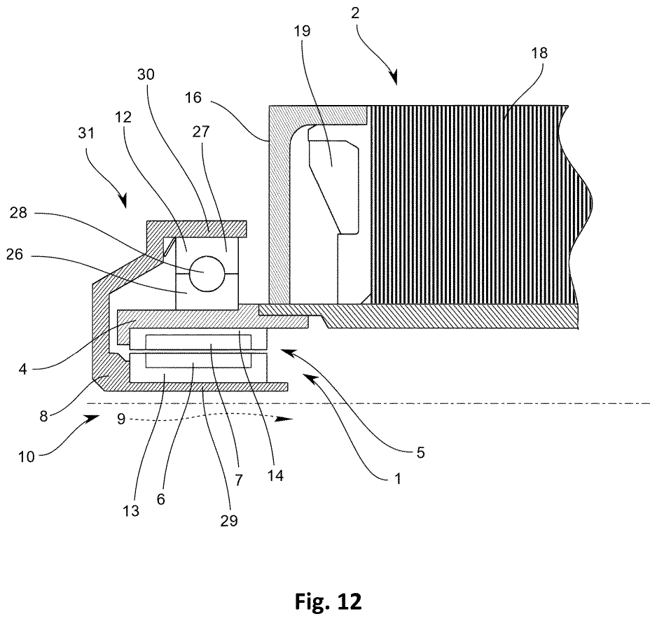

FIG. 12 shows the hollow shaft 4 is rotatably mounted relative to a torsionally rigid connection structure 25 by a rolling bearing 12. As shown, the connection structure 25 is the lance 8. The secondary winding 7 of the inductive transmitter 5 is also arranged inside the hollow shaft 4 here and is connected thereto for conjoint rotation therewith, while the primary winding 6 of the inductive transmitter 5 is positioned therein in a torsionally rigid manner relative to the hollow shaft 4. As shown, the primary winding 6 is arranged on a lance 8 extending axially into the interior of the hollow shaft 4.

The rolling bearing 12 has an inner ring 26 and an outer ring 27, between which a plurality of rolling elements 28 is accommodated, where the inner ring 26 is connected to the hollow shaft 4 for conjoint rotation and the outer ring 27 is connected to the lance 8 for conjoint rotation.

The lance 8 has a first hollow cylindrical cylinder ring section 29, on the outer lateral surface of which the primary winding 6 is arranged, and the lance 8 also has a second cylinder ring section 30 arranged coaxially to the first cylinder ring section 29, on the inner lateral surface of which the outer ring 27 of the rolling bearing 12 is arranged, wherein the first cylinder ring section 29 has a smaller diameter than the second cylinder ring section 30. The rolling bearing 12, the hollow shaft 4, the lance 8 and the inductive transmitter 5 form a modular structural unit 31.

Even if it is not shown in FIG. 12, the contactless energy transmission device 1 can have rectifier electronics 11, which are also arranged inside the hollow shaft 4 and connected thereto for conjoint rotation therewith.

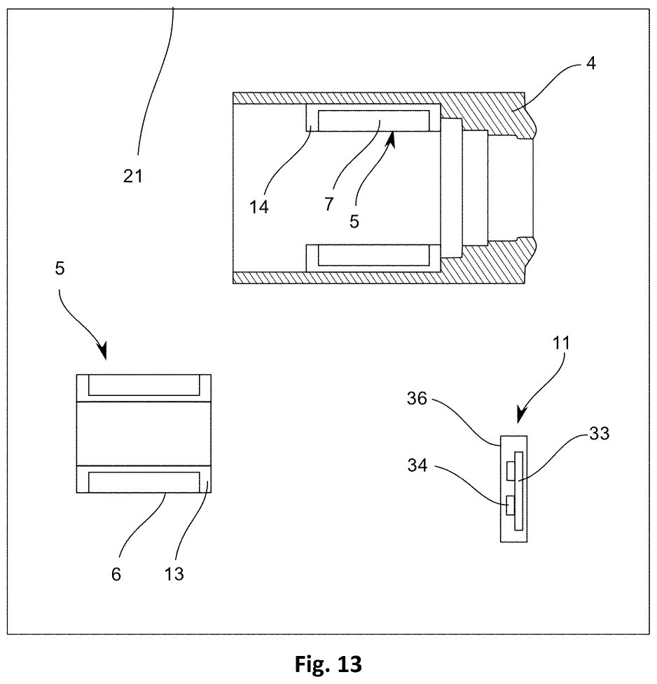

FIG. 13 shows another possible kit-of-parts 21 for producing a contactless energy transmission device 1 for a rotor 2 of an electric machine 3. It includes an inductive transmitter 5 which has an energizable primary winding 6 and a secondary winding 7 which is spaced apart therefrom and can be electrically conductively coupled to a winding of the rotor 2, and a hollow shaft 4 which can be coupled to the rotor 2 of the electric machine 3 in a torque-transmitting manner. Furthermore, the kit-of-parts 21 has rectifier electronics 11 that can be connected to the secondary winding 7, which can be positioned inside the hollow shaft 4 and can be connected thereto for conjoint rotation therewith.

For example, the following method for assembling a rotor 2 of an electric machine 3 can be carried out using the kit-of-parts 21 known from FIG. 13. Firstly, a hollow shaft 4 which can be coupled to the rotor 2 of the electric machine 3 in a torque-transmitting manner is provided, and an inductive transmitter 5 which has an energizable primary winding 6 and a secondary winding 7 which is spaced apart therefrom and can be electrically conductively coupled to a winding of the rotor 2 is provided. Rectifier electronics 11 that can be coupled to the secondary winding 7 are also provided.

Then, the rectifier electronics 11 are inserted into the hollow shaft 4 so that the rectifier electronics 11 are connected to the hollow shaft 4 for conjoint rotation. Finally, the rectifier electronics 11 can then be connected to the secondary winding 7 of the inductive transmitter 5.

The above description is therefore not to be regarded as limiting, but rather as illustrative. The following claims are to be understood as meaning that a stated feature is present in at least one example of the disclosure. This does not exclude the presence of further features. Where the claims and the above description define ‘first’ and ‘second’ features, this designation serves to distinguish between two features of the same type without defining an order of precedence.

### REFERENCE NUMERALS

1 Energy transmission device
2 Rotor
3 Electric machine
4 Hollow shaft
5 Transmitter
6 Primary winding
7 Secondary winding
8 Lance
9 Cooling fluid
10 Cooling channel
11 Rectifier electronics
12 Rolling bearing
13 Primary core
14 Secondary core
15 Star cap
16 Rotor cover
17 Housing structure
18 Laminated rotor core
19 Rotor winding head
20 Rolling bearing
21 Kit-of-parts
22 Stator
23 Drive train
24 Motor vehicle
25 Connection structure
26 Inner ring
27 Outer ring
28 Rolling elements
29 Cylinder ring section
30 Cylinder ring section
31 Unit
32 Rotor shaft
33 Circuit board
34 Electronic components
35 Contour
36 Housing

1. A contactless energy transmission device for a rotor of an electric machine having a separately excited synchronous machine inside a drive train of a motor vehicle, the contactless energy transmission device comprising:
a hollow shaft coupled to the rotor of the electric machine in a torque-transmitting manner; and
an inductive transmitter having an energizable primary winding and a secondary winding which is spaced apart therefrom and can be electrically conductively coupled to a winding of the rotor, wherein:
the secondary winding of the inductive transmitter is arranged inside the hollow shaft and is connected thereto for conjoint rotation therewith, while the primary winding of the inductive transmitter is positioned therein in a torsionally rigid manner relative to the hollow shaft.

2. The contactless energy transmission device of claim 1, wherein the primary winding and the secondary winding of the inductive transmitter are arranged coaxially to one another inside the hollow shaft.

3. The contactless energy transmission device of claim 1, wherein the primary winding is arranged on a lance extending axially into an interior of the hollow shaft.

4. The contactless energy transmission device of claim 3, wherein the lance has at least one cooling channel through which a cooling fluid can flow.

5. The contactless energy transmission device of claim 3, further comprising:
rectifier electronics arranged inside the hollow shaft and connected thereto for conjoint rotation therewith.

6. The contactless energy transmission device of claim 5, wherein the lance is mounted relative to the hollow shaft by a rolling bearing arranged in the hollow shaft.

7. The contactless energy transmission device of claim 1, wherein the secondary winding has an axial extension greater than 50% of a radial outer diameter of the secondary winding.

8. A kit-of-parts for producing a contactless energy transmission device for a rotor of an electric machine including a separately excited synchronous machine inside a drive train of a motor vehicle, the kit-of-parts comprising:
an inductive transmitter having an energizable primary winding and a secondary winding spaced apart therefrom and electrically conductively coupled to a winding of the rotor;
a hollow shaft coupled to the rotor of the electric machine in a torque-transmitting manner, and the secondary winding of the inductive transmitter arranged inside the hollow shaft and connected thereto for conjoint rotation therewith; and
a lance inserted axially into an interior of the hollow shaft, on which the primary winding of the inductive transmitter is arranged.

9. A rotor of an electric machine including a separately excited synchronous machine inside a drive train of a motor vehicle, comprising a contactless energy transmission device of claim 1.

10. An electric machine including a separately excited synchronous machine inside a drive train of a motor vehicle, comprising a rotor of claim 9.

11. A method for assembling a rotor of an electric machine including a separately excited synchronous machine inside a drive train of a motor vehicle, the method comprising:
providing an inductive transmitter which has an energizable primary winding and a secondary winding which is spaced apart therefrom and can be electrically conductively coupled to a winding of the rotor, and
providing a hollow shaft which can be coupled to the rotor of the electric machine in a torque-transmitting manner, and
inserting the inductive transmitter into the hollow shaft.

12. The contactless energy transmission device of claim 7, wherein the secondary winding has an axial extension greater than 70% of the radial outer diameter of the secondary winding.
